(19) United States
(12) Patent Application Publication
(10) Pub. No.: US 2016/0342284 A1
(43) Pub. Date: Nov. 24, 2016

(54) ELECTRONIC DEVICE AND NOTE REMINDER METHOD

(71) Applicant: HON HAI PRECISION INDUSTRY CO., LTD., New Taipei (TW)

(72) Inventor: CHIA-LI YAO, New Taipei (TW)

(21) Appl. No.: 14/790,629

(22) Filed: Jul. 2, 2015

(30) Foreign Application Priority Data
May 19, 2015 (TW) 104115870

(51) Int. Cl. G06F 3/0481; H04L 29/08; H04W 4/02

(52) U.S. Cl. CPC G06F 3/0481; H04W 4/02; H04L 67/18

(57) ABSTRACT

In a note reminder method, a current location of the electronic device is obtained. When a distance between the current location and a location associated with a note is determined to be less than or equal to a predefined distance, the note reminder is executed.

### CROSS-REFERENCE TO RELATED APPLICATIONS

This application claims priority to Taiwanese Patent Application No. 104115870 filed on May 19, 2015, the contents of which are incorporated by reference herein.

### FIELD

The subject matter herein generally relates to notes management, and more specifically relates to a method for executing a note reminder based on location and an electronic device using the method.

### BACKGROUND

A note is a briefly written record that is used to remind somebody to do something at a certain time. Generally, when arrival time of the note is recorded, the user is notified in a predefined way.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of one embodiment of a hardware environment for executing a note reminder system.

FIG. 2 is a block diagram of one embodiment of function modules of the note reminder system in FIG. 1.

FIG. 3 is a flowchart of one embodiment of a method for executing a note reminder.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The present disclosure, including the accompanying drawings, is illustrated by way of examples and not by way of limitation. Several definitions that apply throughout this disclosure will now be presented. It should be noted that references to “an” or “one” embodiment in this disclosure are not necessarily to the same embodiment, and such references mean “at least one.”

Furthermore, the word “module,” as used hereinafter, refers to logic embodied in hardware or firmware, or to a collection of software instructions, written in a programming language, such as, for example, Java, C, or assembly. One or more software instructions in the modules may be embedded in firmware. It will be appreciated that modules may comprise connected logic units, such as gates and flip-flops, and may comprise programmable units, such as programmable gate arrays or processors. The modules described herein may be implemented as either software and/or hardware modules and may be stored in any type of non-transitory computer-readable storage medium or other computer storage device. The term “comprising,” when utilized, means “including, but not necessarily limited to”; it specifically indicates open-ended inclusion or membership in the so-described combination, group, series and the like.

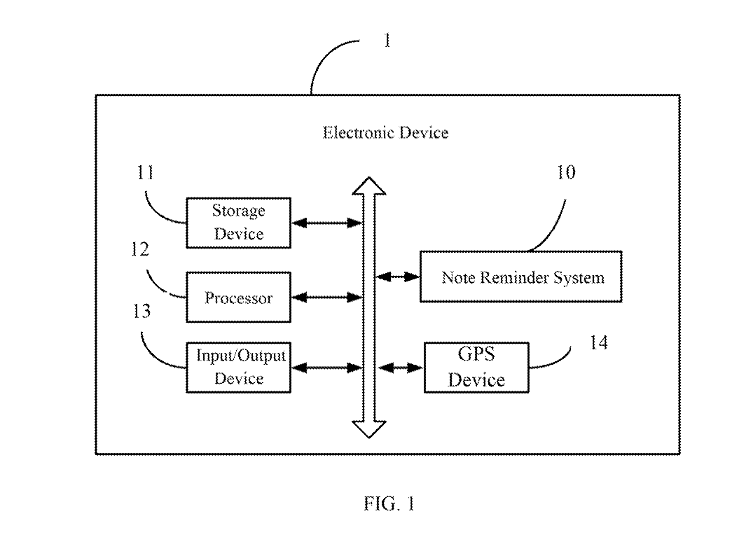

FIG. 1 is a block diagram of one embodiment of a hardware environment for executing a note reminder system. The note reminder system 10 is installed and run in an apparatus, for example an electronic device 1. In at least one embodiment as shown in FIG. 1, the electronic device 1 includes, but is not limited to, a storage device 11, at least one processor 12, an input/output device 13, and a Global Positioning System (GPS) device 14. The electronic device 1 can be a tablet computer, a notebook computer, a smart phone, a personal digital assistant (PDA), or other suitable electronic device. FIG. 1 illustrates only one example of the electronic device 1; others can include more or fewer components than illustrated, or have a different configuration of the various components in other embodiments.

The note reminder system 10 can determine whether a distance between a current location of the electronic device 1 and a target location associated with a note is less than or equal to a predefined distance. And when the distance between the current location and the target location associated with the note is less than or equal to the predefined distance, the note is shown as reminder for a user.

In at least one embodiment, the storage device 11 can include various types of non-transitory computer-readable storage mediums. For example, the storage device 11 can be an internal storage system, such as a flash memory, a random access memory (RAM) for temporary storage of information, and/or a read-only memory (ROM) for permanent storage of information. The storage device 11 can also be an external storage system, such as a hard disk, a storage card, or a data storage medium. The at least one processor 12 can be a central processing unit (CPU), a microprocessor, or other data processor chip that performs functions of the management system 10 in the electronic device 1. The input/output device 13 can be used by a user to input commands and display information. In the embodiment, the input/output device 13 is a touch screen. In other embodiments, the input/output device 13 can include an input device such as a mouse, a keyboard, or a touch panel, and an output device such as a display screen. The GPS device 14 can provide a current location of the electronic device 1.

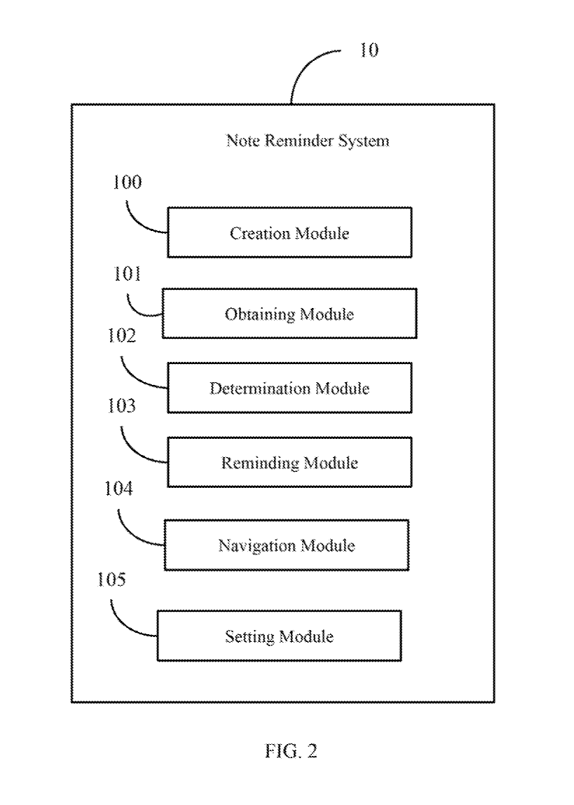

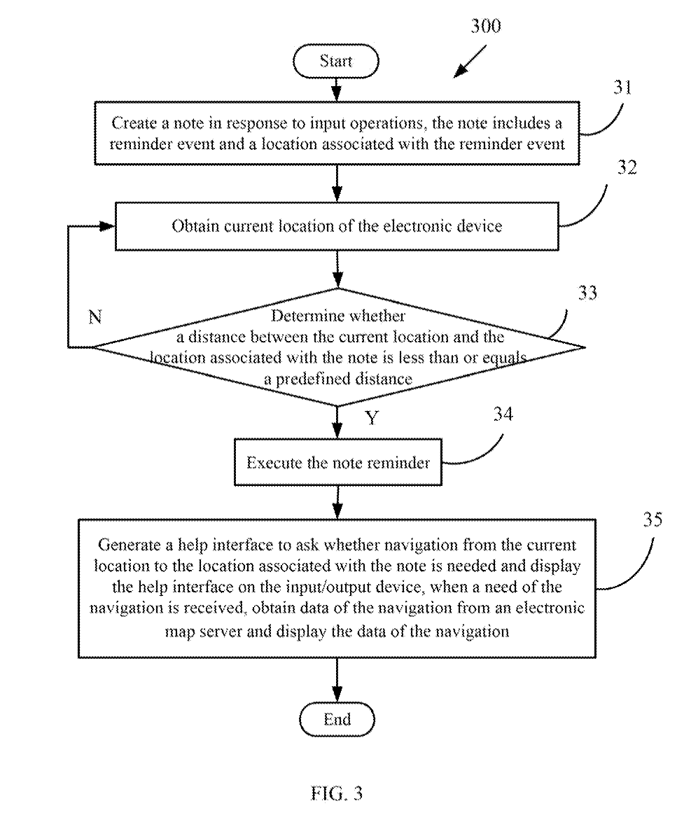

FIG. 2 is a block diagram of one embodiment of the function modules of the note reminder system 10. In at least one embodiment, the note reminder system 10 can include a creation module 100, an obtaining module 101, a determination module 102, a reminding module 103, a navigation module 104 and a setting module 105. The function modules 100-105 can include computerized codes in the form of one or more programs, which are stored in the storage device 11. The processor 12 executes the computerized codes to provide functions of the function modules 100-105. A detailed description of the functions of the modules 100-105 is given below in reference to FIG. 3.

FIG. 3 illustrates a flowchart of one embodiment of a method for executing a note reminder. The example method 300 is provided by way of example, as there are a variety of ways to carry out the method. The method 300 described below can be carried out using the configurations illustrated in FIGS. 1-3, for example, and various elements of these figures are referenced in explaining example method 300. Each block shown in FIG. 3 represents one or more processes, methods or subroutines, carried out in the exemplary method 300. Furthermore, the illustrated order of blocks is by example only and the order of blocks can change according to the present disclosure. The exemplary method 300 can begin at block 301. Depending on the embodiment, additional blocks can be added, others removed, and the ordering of the blocks can be changed.

At block 31, the creation module creates a note in response to input operations on the input/output device. In the embodiment, the note includes a reminder event and a location associated with the reminder event.

In the embodiment, the created note includes one or more elements from text information, picture information, audio information, video information. In one embodiment, the electronic device 1 is provided with an electronic map. The electronic map is displayed on the input/output device 13. A user applies a selection operation on the electronic map to select a location, and an input operation on the input/output device 13 to input content of the reminder event associated with the selected location. The creation module 100 creates the note based on the selection operation and the input operation.

In other embodiments, the creation module 100 provides an input box in response to a note creation operation. The note creation operation can be an operation to select a menu item for creating notes. The user applies input operations in the input box to input a location and content of the reminder event associated with the location. The creation module 100 creates the note based on the input operations. The creation module 100 further stores the created notes in the storage device 11.

At block 32, the obtaining module obtains the current location of the electronic device provide by the GPS device.

At block 33, the determination module determines whether a distance between the current location and the location associated with the note is less than or equal to a predefined distance; if yes, the process goes to block 34; otherwise, the process goes back to block 32.

In one embodiment, the predefined distance is predefined according to a need of a user. In the embodiment, the setting module 105 can set the predefined distance in response to input operations of the user on the input/output device 13. In one embodiment, the user can directly input a distance value via the input/output device 13. In other embodiments, the user can select a travel method and set a travel time associated with the travel method. For example, the user can select walk and set the walking time to be 5 minutes. The user also can select a method of travel from the group consisting of driving, taxi, bus, or subway and set the travel time to be 10 minutes. The setting module 105 can obtain the predefined distance according to the travel method and the travel time set by the user. For example, the setting module 105 obtains an average walking speed or an average speed of a selected vehicle from a network electronic map database. The setting module 105 calculates the predefine distance according to the obtained average speed and the time set by the user.

At block 34, the reminding module executes the note reminder.

In one embodiment, the reminding module 103 controls to display content of the note on the input/output device 13 or sounds out the content of the note. In other embodiments, the reminding module 103 further controls the electronic device 1 to vibrate or produce a particular sound.

At block 35, the navigation module generates a help interface to ask the user of the electronic device whether navigation from the current location to the location associated with the note is needed and displays the help interface on the input/output device. When a need of the navigation from the current location to the location associated with the note is received, the navigation module obtains data of the navigation from an electronic map server via internet and displays the data of the navigation.

The data of the navigation includes, but is not limited to, a distance, a path, vehicles, time cost, and money cost from the current location to the location associated with the note.

In one embodiment, the help interface includes two operation items including a “yes” and a “no”. When the item of “yes” is selected, the request for providing the navigation is generated and the navigation is provided. When the item of “no” is selected, the navigation from the current location to the location associated with the note will not be provided.

The embodiments shown and described above are only examples. Many details are often found in the art and many such details are therefore neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A method of a note reminder executable by at least one processor of an electronic device, the note comprising a reminder event and a location associated with the reminder event; the method comprising:
obtaining a current location of the electronic device;
determining whether a distance between the current location and the location associated with the note is less than or equal to a predefined distance; and
executing the note reminder when the distance between the current location and the location associated with the note is less than or equal to a predefined distance.

2. The method according to claim 1, further comprising creating the note associated with a location; and storing the note in the electronic device.

3. The method according to claim 2, wherein the notes associated with locations is created by:
providing an electronic map;
receiving a selection operation on the electronic map to select a location and an input operation for inputting content of the reminder event associated with the selected location; and
creating the note based on the selection operation and the input operation.

4. The method according to claim 2, wherein the notes associated with locations is created by:
providing an input box;
receiving input operations in the input box to input a location and content of the reminder event associated with the input location; and
creating the note based on the input operations.

5. The method according to claim 1, further comprising:
generating a help interface to ask whether navigation from the current location to the location associated with the note is needed;
displaying the generated help interface;
obtaining data of the navigation from an electronic map server via internet when receiving a need of the navigation from the current location to the location associated with the note; and
displaying the data of the navigation.

6. An electronic device, comprising:
a processor; and
a storage device that stores a note and one or more programs, the note comprising a reminder event and a location associated with the event, the programs which, when executed by the processor, cause the processor to:
obtain a current location of the electronic device;
determine whether a distance between the current location and the location associated with the note is less than or equal to a predefined distance; and
execute the note reminder when the distance between the current location and the location associated with the note is less than or equal to a predefined distance.

7. The electronic device according to claim 6, further the processor is caused to:
create the note associated with a location; and
store the note in the electronic device.

8. The electronic device according to claim 7, wherein the notes associated with locations is created by:
providing an electronic map;
receiving a selection operation on the electronic map to select a location and an input operation for input content of the reminder event associated with the selected location; and
creating the note based on the selection operation and the input operation.

9. The electronic device according to claim 7, wherein the notes associated with locations is created by:
providing an input box;
receiving input operations in the input box to input a location and content of the reminder event associated with the input location; and
creating the note based on the input operations.

10. The electronic device according to claim 6, wherein the processor is caused to:
generate a help interface to ask whether navigation from the current location to the location associated with the note is needed;
display the generated help interface;
obtain data of the navigation from an electronic map server via internet when receiving a need of the navigation from the current location to the location associated with the note; and
display the data of the navigation.

11. A non-transitory storage medium having stored thereon instructions that, when executed by a processor of an electronic device, causes the processor to perform a method for a not reminding, wherein the method comprises:
obtaining a current location of the electronic device;
determining whether a distance between the current location and the location associated with the note is less than or equal to a predefined distance; and
executing the note reminder when the distance between the current location and the location associated with the note is less than or equal to a predefined distance.

12. The non-transitory storage medium according to claim 11, further comprising creating the note associated with a location; and storing the note in the electronic device.

13. The non-transitory storage medium according to claim 12, wherein the notes associated with locations is created by:
providing an electronic map;
receiving a selection operation on the electronic map to select a location and an input operation for input content of the event associated with the selected location; and
creating the note based on the selection operation and the input operation.

14. The non-transitory storage medium according to claim 12, wherein the notes associated with locations is created by:
providing an input box;
receiving input operations in the input box to input a location and content of the event associated with the input location; and
creating the note based on the input operations.

15. The non-transitory storage medium according to claim 11, further comprising:
generating a help to ask whether navigation from the current location to the location associated with the note is needed;
displaying the generated help interface;
obtaining data of the navigation from a electronic map server via internet when receiving a need of the navigation from the current location to the location associated with the note; and
displaying the data of the navigation.
